(19) United States
(12) Patent Application Publication
(10) Pub. No.: US 2023/0322591 A1
(43) Pub. Date: Oct. 12, 2023

(54) ELECTRODIALYSIS DEVICE AND METHOD FOR SELECTIVE REMOVAL OF DRINKING WATER TARGET IONS

(71) Applicant: RESEARCH CENTER FOR ECO-ENVIRONMENTAL SCIENCES, CHINESE ACADEMY OF SCIENCES, Beijing (CN)

(72) Inventors: Min YANG, Beijing (CN); Binghui TIAN, Beijing (CN); Sheng LUO, Beijing (CN); Ming ZHU, Beijing (CN)

(73) Assignee: RESEARCH CENTER FOR ECO-ENVIRONMENTAL SCIENCES, CHINESE ACADEMY OF SCIENCES, Beijing (CN)

(21) Appl. No.: 18/067,718

(22) Filed: Dec. 18, 2022

Related U.S. Application Data
(63) Continuation of application No. PCT/CN2022/130791, filed on Nov. 9, 2022.

(30) Foreign Application Priority Data
Apr. 8, 2022 (CN) 202210364197.1

(51) Int. Cl. C02F 1/469; B01D 61/44; B01D 61/50

(52) U.S. Cl. CPC C02F 1/4693; B01D 61/445; B01D 61/50; C02F 2201/46115

(57) ABSTRACT

An electrodialysis device and method for selective removal of drinking water target ions were provided. It belongs to the technical field of drinking water safety. A method of electrodialysis with slightly brackish water is proposed. By means of ion electromigration control, the resistance is converted from the single membrane resistance to the diffusion boundary layer resistance; and the diffusion boundary layer is fully compressed by controlling the electrodialysis membrane, the electrodialysis membrane stack, and the electrodialysis process parameters. So that the relative electromigration rate of the target ions is improved. According to the method, the initial concentration effect, the competition effect, the synergistic effect, the concentration diffusion, the differential pressure permeation, and other influences of electrodialysis are integrated for selectively removing the target ions. It significantly reduces the cost of water treatment and improves the long-term stability and operational applicability of the device.

### CROSS-REFERENCE TO RELATED APPLICATIONS

This application is a continuation of International Patent Application No. PCT/CN2022/130791 with a filing date of Nov. 9, 2022, designating the United States, now pending, and further claims priority to Chinese Patent Application No. 202210364197.1 with a filing date of Apr. 8, 2022. The content of the aforementioned applications, including any intervening amendments thereto, are incorporated herein by reference.

### TECHNICAL FIELD

The present invention belongs to the technical field of drinking water safety and specifically relates to an electrodialysis device and method for the selective removal of drinking water target ions.

### BACKGROUND OF THE PRESENT INVENTION

Poor drinking water quality has become a classic bottleneck problem of disease prevention and control. The reason for that could be no standard drinking water source exists in remote or over-dispersed areas and large-scale centralized water supply cannot be achieved due to remote or over-dispersion. Solving the problem of poor drinking water in remote areas should be given primary importance among priorities in the future. Rich populations are often able to obtain higher levels of water service at lower prices. However, poverty people often need to pay extremely high costs in order to obtain equal even worse quality and services of obtaining water. A water source does not reach the standard, ultra-long water taking distance, and lack of public facilities and professional service personnel make people in a low development area in the world usually pay 5 to 10 times more than people in a high development area. Therefore, the non-conventional water source low-cost processing of the home-entry water supply technology becomes one of the breakthrough directions in order to solve the worldwide problem of sustainable development.

One of the high-cost difficult problems with “substandard drinking water source” treatment is a large number of available groundwater-sourced total dissolved solids (TDS) and fluorine, hardness, arsenic, nitrate radicals, iron, manganese, and other soluble ions exceeding the standard. The existing art of water treatment takes desalination as the main operation. Desalination includes a physical and a chemical methods such as adsorption, filtration, and chemical precipitation. The inventors thought desalination is now significantly reduced in application due to high cost, low efficiency, and secondary contamination of the waste liquid. Membrane technologies such as anti-penetration, nanofiltration, electrodialysis, and the like have commonly been used for the desalination of drinking water. After many years of application and promotion, anti-penetration is widely used. However, in recent years, the inventors thought that although the desalination efficiency of anti-penetration is high and the water quality is good, in the drinking water treatment process of slightly brackish water (TDS is less than 3000 ppm), the treatment cost is high. Especially for the problems caused by partial solubility ions such as fluorine, hardness, arsenic, nitrate, iron, manganese, and the like. The inventors thought desalination by anti-penetration technology lacks selectivity. While the operation cost of invalid desalination caused by the full-ion removal mode is high. The problem of strong brine and the like is also cost by a lack of selectivity. So it is difficult to realize the large-scale home-entry water supply of villages and towns. Electrodialysis desalination has ion removal selectivity because different ions have different competitive electromigration rates during electrodialysis. But the inventors thought the ion selectivity is ignored because electrodialysis used total ion removal desalination mode. So the advantages of electrodialysis are not fully embodied. Problems such as easy to plug, short life of the electrode service, complex operation of the multi-chamber structure, and the like make electrodialysis lack of competitiveness. In recent years, highlighting the advantages of ion selectivity and overcoming the disadvantages of electrodialysis has become one of the hot spots for research on brackish water.

SUMMARY OF PRESENT INVENTION

As shown in FIG. 1, it is shown that when the concentration of the total dissolved solids (TDS) in the raw slightly brackish water is lower than 3000 ppm, the ion electromigration control resistance is rapidly and linearly increased by ten times. The resistance is also converted from the single membrane resistance to the diffusion boundary layer resistance, and the resistance of the fluorine ion diffusion boundary layer is increased much larger than that of chloride ions. A novel ion exchange membrane is developed, and the electrodialysis resistance is reduced, so the water treatment desalination efficiency is improved. Different target ions have different competitive electromigration rates in the electrodialysis desalination process. The concentration of raw slightly brackish water treated by electrodialysis is low (the total dissolved solids are less than 3000 ppm), and the ion electromigration control resistor is converted from the single membrane resistance to the diffusion boundary layer resistance. Thereby, an electrodialysis method and equipment for the selective removal of target ions by ensemble-controlled compressed diffusion boundary layer was invented.

An electrodialysis method for selective removal of drinking water target ions includes: treating raw slightly brackish water by using an electrodialysis desalination process to obtain desalted water.

The electrodialysis desalination process processes the raw slightly brackish water by controlling an electrodialysis membrane, an electrodialysis membrane stack, and electrodialysis process parameters.

The calculation general formula of the selective separation coefficient is:

$${S}_{B}^{A} = \frac{{C}_{A ( t )} / {C}_{A ( 0 )} - {C}_{B ( t )} / {C}_{B ( 0 )}}{( 1 - {C}_{A ( t )} / {C}_{A ( 0 )} ) + ( 1 - {C}_{B ( t )} / {C}_{B ( 0 )} )} .$$

The electrodialysis membrane includes, but is not limited to, any one of a controllable channel membrane, a compression diffusion boundary layer membrane, and an ion exchange membrane. An aperture of the electrodialysis membrane is less than 1 micron, and the selective separation coefficient of the electrodialysis membrane is −1 to 1. A represents a target ion, and B represents total dissolved solids in a selected standard ion or actual solution in actual use.

The electrodialysis membrane stack includes at least one segment, at least one stage, and at least one chamber. The segment is the number of repeated flows of the raw slightly brackish water in the electrodialysis membrane stack; the value of the stage is the number of electrode plates in the electrodialysis membrane stack reduced by 1, and the chamber is formed by separating the electrodialysis membrane.

Some embodiments disclose an electrodialysis method for the selective removal of drinking water target ions. The electrodialysis device is assembled according to the method in the embodiment, and after the aperture of the electrodialysis membrane is controlled to be less than 1 micron, the used electrodialysis membrane can satisfy the selective separation coefficient calculated by the above-mentioned formula. After the content of the TDS in the actual solution in the drinking water is determined, the separation performance coefficient of the method for specific ions can be obtained by means of the above-mentioned formula. By means of the formula calculation of the present invention, a suitable electrodialysis assembly method can be reversely deduced, so that the concentration of specific ions in drinking water can meet corresponding regulations or requirements.

Some embodiments disclose the usage of stages, segments, and chambers of a particular electrodialysis membrane stack. Through the arrangement of the stages, the segments, and the chambers, excellent separation performance can be achieved, and separation performance can be calculated and characterized through the formula of the separation coefficient.

The calculation general formula of the selective separation coefficient is:

$${S}_{B}^{A} = \frac{{C}_{A ( t )} / {C}_{A ( 0 )} - {C}_{B ( t )} / {C}_{B ( 0 )}}{( 1 - {C}_{A ( t )} / {C}_{A ( 0 )} ) + ( 1 - {C}_{B ( t )} / {C}_{B ( 0 )} )} .$$

S_{B} represents a selective separation coefficient. In some embodiments, different selective separation coefficients are calculated by the formula, and different selective separation coefficients in the embodiments may be replaced by kx where x is an unspecified parameter and determined according to a specific use. kx and S_{B}^{A} are equally related.

In the general formula of the selective separation coefficient, C_{A(t)} is the ion concentration of A ion at time t; C_{A(0)} is the initial ion concentration of A ion; C_{B(t)} is the ion concentration of B ion at time t; C_{B(0)} is the ion concentration of B ion. The S value range is −1 to 1 depending on the mass transfer rate of the A ions and B ions. If the A ion mass transfer rate is higher than B ions, the S value is between −1 and 0; otherwise, the S value is between 0 and 1. In the present formula, A may represent a target ion, and B may represent a selected standard ion or TDS in actual use.

Preferably, a separation coefficient for selectively removing the target ions is obtained from the following formula:

K=[k_{liquid}·k_{field}·(k_{membrane}·k_{segment}+k_{stage})]k^{chamber};

kx represents the selective separation coefficient; x represents a liquid, a field, a membrane, a segment, a stage, or a chamber. The range of K can be 0.3-0.9.

Through the general formula of the selective separation coefficient, the selective separation coefficients under different parameters are calculated according to different parameters during use. Through research, the function of k_{liquid}, k_{field}, k_{membrane}, k_{segment}, k_{stage}, and k_{chamber} can be calculated by the formula, and the specific K value can be further calculated by the formula. In addition, by means of the formula calculation of the present invention, a suitable electrodialysis assembly method can be reversely deduced, so that the concentration of specific ions in drinking water can meet corresponding regulations or requirements. The separation coefficient of the method can be 0.3-0.9. and compared with the prior art, the separation coefficient obtained by the method is higher, and the requirement for the removal concentration of specific ions is low.

In the separation coefficient for selectively removing the target ions, k_{liquid} represents a selective separation coefficient of a target solution; k_{field} represents an electrodialysis process parameter multi-field control selective separation coefficients such as electrodialysis membrane stack voltage, electrodialysis membrane stack flow rate, concentration difference of a dense dilute chamber, and pressure difference of a dense dilute chamber; k_{membrane} represents an electrodialysis membrane selective separation coefficient; k_{segment} represents a membrane selective separation coefficient of electrodialysis membrane stack; k_{stage} represents a stage selective separation coefficient of electrodialysis membrane stack.

Preferably, the electrodialysis membrane stack includes 1 to 5 stages. The number of stages of the electrodialysis membrane stack is the same as the number of segments; the stage voltage of the first segment can be 0.1-2.0 volts/pair, and the voltage of other segments can be 30 -300% of the stage voltage of the first segment.

Preferably, the electrodialysis membrane stack includes 1 to 5 chambers, each same chamber is circulated and refluxed, and the reflux ratio of each same chamber is 1-4. The same chamber means that the desalination chamber refluxes in the desalination chamber and the concentrated chamber refluxes in the concentrated chamber, and the desalination chamber does not reflux with the concentrated chamber.

Preferably, the chamber of the electrodialysis membrane stack is filled with ion resin, the filling rate can be 5-80% by volume.

Preferably, a bipolar membrane chamber is added to the chamber of the electrodialysis membrane stack, and the proportion of the bipolar membrane chamber is 1-30% based on the number of chambers.

Preferably, in selective decalcification, the conventional desalination voltage can be 0.5 volts/pair. The parameters of the electrodialysis membrane stack voltage can be controlled as 30-80% of the conventional desalination voltage.

Preferably, in selective decalcification, the conventional desalination flow rate can be 0.5 m/sec. The parameters of the electrodialysis membrane stack flow rate can be controlled as 30-170% of the conventional desalination flow rate.

Preferably, in selective decalcification, the parameters of the electrodialysis membrane stack flow rate can be controlled as dense dilute chamber concentration difference less than 1200 ppm.

Preferably, in selective decalcification, the parameters of the electrodialysis membrane stack flow rate are controlled as the dense dilute chamber pressure difference ratio can be 1.0-0.5.

Preferably, in selective defluorination, the conventional desalination voltage can be 0.5 volts/pair. The parameters of the electrodialysis membrane stack voltage can be controlled as 70-200% of the conventional desalination voltage.

Preferably, in selective defluorination, the conventional desalination flow rate can be 0.5 m/sec. The parameters of the electrodialysis membrane stack flow rate can be controlled as 110-190% of the conventional desalination flow rate.

Preferably, in the selective defluorination, the parameters of the electrodialysis membrane stack flow rate are controlled as dense dilute chamber concentration difference less than 1200 ppm.

Preferably, in selective defluorination, the parameters of the electrodialysis membrane stack flow rate are controlled as the dense dilute chamber pressure difference ratio can be 1.0-0.2.

The present disclosure discloses an electrodialysis method and equipment for selectively removing target ions from a set control compression diffusion boundary layer. By means of ion electromigration control, the resistance is converted from the single membrane resistance to the diffusion boundary layer resistance; and the diffusion boundary layer is fully compressed by controlling the electrodialysis membrane, the electrodialysis membrane stack, and the electrodialysis process parameters. So that the relative electromigration rate of the target ions is improved. According to the method, the initial concentration effect, the competition effect, the synergistic effect, the concentration diffusion, the differential pressure permeation, and other influences of electrodialysis are integrated for selectively removing the target ions. It significantly reduces the cost of water treatment and improves the long-term stability and operational applicability of the device.

Preferably, the electrodialysis process parameter is an electrodialysis process. Multi-field control may include an electric field, a flow field, a concentration difference, a pressure difference, etc.

Preferably, the set control compression diffusion boundary layer is characterized in that the selective separation coefficient of the set control model for selectively removing the target ions is a function of five factors such as a segment, a stage, a field, a chamber, and a membrane. The specific functioning relationship is:

K=[k_{liquid}·k_{field}·(k_{membrane}+k_{segment}+k_{stage})]^{k}^{_{chamber}}.

The “film, segment, stage” selective separation coefficient is the addition relationship, “chamber” is a power exponential relationship, and “solution, process, membrane grade membrane stack” is a product relationship.

More preferably, the electrodialysis membrane includes one or more controllable channel membranes, one or more compression diffusion boundary layer membranes, and one or more ion exchange membranes. The selective separation coefficient of the electrodialysis membrane can be calculated by:

$${S}_{B}^{A} = \frac{{C}_{A ( t )} / {C}_{A ( 0 )} - {C}_{B ( t )} / {C}_{B ( 0 )}}{( 1 - {C}_{A ( t )} / {C}_{A ( 0 )} ) + ( 1 - {C}_{B ( t )} / {C}_{B ( 0 )} )} .$$

The selective separation coefficient of the electrodialysis membrane should be −1 to 1. The function of the electrodialysis membrane is to reduce the resistance of the diffusion boundary layer and improve the competitive electromigration rate of the target ions.

More preferably, the characteristic of the electrodialysis membrane stack is that the electrodialysis membrane stack includes at least one segment, at least one stage, and at least one chamber.

More preferably, the electrodialysis membrane stack includes 1-5 segments. The first segment and/or the second segment are high flow rates (greater than 0.5 meter/second), low voltage (less than 0.5 volts/pair), short residence time (less than 3.2 seconds), and are mainly used for target selective removal of high electromigration rate ions such as calcium, magnesium and chlorine, sulfuric acid, bicarbonate radicals and nitrate radicals. It can also be used for high initial concentrations of the target ions (10-2000 ppm). The second segment and/or the third segment are low flow rates (less than 0.5 meter/second), high voltage (more than 0.5 volts/pair), and long residence time (1.6-9.6 seconds), and are mainly used for target selective removal of low electromigration rate ions such as sodium and fluorine. It can also be used for low initial concentrations of the target ions (0.5-10 ppm). The third segment and/or the fourth segment are low flow rates (less than 0.5 meter/second), high voltage (more than 0.5 volts/pair), long residence time (1.6-12.8 seconds), and are mainly used for target selective removal of low electromigration rate ions such as heavy metals and arsenic. It can also be used for low initial concentrations of the target ions (10-500 ppb). The fourth segment and/or the fifth segment are high flow rates (greater than 0.5 meter/second), high voltage (more than 0.5 volts/pair), and long residence time (9.6-16.0 seconds), and are mainly used for target selective removal of super high initial concentration of the target ions (3000-40000 ppm).

The above-mentioned residence time cannot be accurately controlled, and can only be controlled within a certain range. When the method is used, according to specific usage parameters, the residence time of the same batch may be considered to be consistent. In the processing of the segments, the chambers may be communicated and circulated, so the time differences do not result in differences in experimental results. In addition, “multiple segments” may use asymmetric ion exchange membrane pairs and asymmetric flow rates. The membrane log ratio of the first section is 1, and the film log ratio of the 2-5 sections is 0.25-4. In the above description, if the number of segments is 1, control is performed according to a condition of one segment; if the number of segments is 2, the first segment is controlled according to the use mode with the segment number of 1, and the second segment can be controlled according to the specific condition; if the segment number is 3, the first segment is controlled according to the use mode with the segment number of 2, and the third segment can be controlled according to the specific condition; the use of 4 segments and 5 segments is controlled according to the usage mode of 3 and 4 in sequence, and the last segments can be controlled according to the specific condition. The condition of each segment in the method may be arbitrarily applied to all segments, and different ions are correspondingly removed under different conditions and may be used as required in practical applications. The specific use of multiple segments is to improve the target ion removal rate (different from the multiple segments of electrodialysis in the prior art to increase the long residence time). The use of multiple segments in the present method is to use different parameters in different segments, and different ions can be removed in different segments respectively.

More preferably, the multi-stage feature in the electrodialysis membrane stack includes 1-5 stages. According to the functioning relationship:

K=[k_{liquid}·k_{field}·(k_{membrane}+k_{segment}+k_{stage})]^{k}^{_{chamber}},

the multi-stage control number is calculated according to the multi-segment number. The voltage of each stage may be consistent, or may not be consistent. The voltage consistency is beneficial to saving cost; and when the voltage is inconsistent, the target selective removal efficiency can be improved. The voltage ratio of the first stage is 0.1-2.0 V. When the voltage ratio of the first stage is set to 1, the voltage of the 2-5 stage could be 0.3-3.

More preferably, the multi-chamber feature in the electrodialysis membrane stack includes 1-5 chambers. The cathode chambers and anode chambers can be optimized and combined according to the target ion selective removal principle. For example, a combination of chambers could be cathode and anode; anode, anode, and cathode; cathode, cathode, and anode; cathode, cathode, anode, anode, and anode; etc. Each chamber can be circulating reflux, and the reflux ratio of each chamber can be 1-4. The reflux ratio is the number of cycles. The ion resin can be filled in the chamber to compress the diffusion boundary layer, and the filling rate is 5-80%. The bipolar membrane chamber can also be added; the pH value is adjusted to compress the diffusion boundary layer, and the number of bipolar membrane chambers is 1-30%.

More preferably, the electrodialysis process parameter is an electrodialysis process. Multi-field control includes an electric field, a flow field, a concentration difference, a pressure difference, etc. Multi-field control can compress the diffusion boundary layer directly and improve the competitive electromigration rate of target ions.

More preferably, in the electric field control of the electrodialysis process, the voltage is a controlling factor for the target ion selective removal efficiency. The electrodialysis membrane pair voltage is controlled so that the diffusion boundary layer can be fully compressed. When the target is selectivity removal of hardness, compared with a conventional desalination voltage, the voltage is reduced and the reduction ratio is 1.2-3. So the calcium ion selectivity removal efficiency is increased. When the target is selectivity removal of fluorine, compared with a conventional desalination voltage, the voltage is increased and the addition ratio is 1.5-4, and the fluorine ion target selectivity removal efficiency is increased.

More preferably, in the flow field control in the electrodialysis process, the flow rate is a controlling factor for the target ion selective removal efficiency. The flow rate of the electrodialysis membrane stack is controlled, and the diffusion boundary layer can be fully compressed. When the target is selectivity removal of hardness, compared with the conventional desalination flow rate, the flow rate is increased, and the addition ratio is 1.1-2.5. The selective removal efficiency of the calcium ion is increased. When the target is selectivity removal of fluorine, compared with the conventional desalination flow rate, the flow rate is increased, and the fluorine ion selective removal efficiency is increased. However, the sensitivity of defluorination is lower than removal of hardness, the flow rate needs to be increased greatly. The ratio is increased by 1.5-6.

More preferably, in the electric field control of the electrodialysis process, the concentration difference is a controlling factor for the target ion selective removal efficiency. The concentration of the dense dilute chamber of the electrodialysis membrane is controlled so that the diffusion boundary layer can be fully compressed and concentration diffusion can be controlled. When the target is selectivity removal of hardness, the calcium ion concentration is high. When the concentration difference is high and the concentration difference is less than 1200 ppm, the water yield should be controlled. The highest water yield should be 80-92%. When the target is selectively defluorinated, the fluorine ion concentration is low. When the concentration difference is low and the concentration difference is less than 2000 ppm, the water yield can be controlled at a high yield, and the highest water yield can reach 90-97%.

More preferably, in the electric field control of the electrodialysis process, the pressure difference of the dense dilute chamber is a controlling factor for the target ion selective removal efficiency. The pressure difference of the dense dilute chamber of the electrodialysis membrane is controlled so that the diffusion boundary layer can be fully compressed and infiltration of pressure difference can be controlled. When the target is selectivity removal of hardness, the calcium ion concentration is high.

Compared with a conventional pressure difference of a dense dilute chamber, the pressure difference ratio should be reduced and the pressure difference ratio could be 1.0-0.5. When the target is selectivity removal of fluorine, compared with a conventional pressure difference of a dense dilute chamber, the pressure difference ratio should be increased and the pressure difference ratio could be 1.0-0.2.

When the number of chambers is not given in the method, the number of the default chambers should be 2.

Preferably, in an electrodialysis method for selectivity removal of hardness, the hardness of raw water can be 450 ppm-600 ppm (in terms of calcium carbonate), and TDS can be 700-900 ppm. Electrodialysis membranes are used for electrodialysis, the selective separation coefficient of the electrodialysis membrane can be 0.4-0.8. The stage of the electrodialysis membrane stack should be 1 and the segment of the electrodialysis membrane stack should be 1. The electrodialysis membrane pairs can be 300 pairs, the flow rate can be 6 m/s and the voltage can be 45 volts. The electrodialysis membrane has a water yield of 85-90%, a dense dilute ratio of 1.0-0.5; K=[k_{liquid}·k_{field}·(k_{membrane}+k_{segment}+k_{stage})]^{k}^{_{chamber}}=0.7-0.9. The electrodialysis membrane also has an output water hardness of 170-450 mg/L,TDS 500-700 ppm. A direct operation cost could be 0.05 yuan/ton or less and investment could be 1.2 million/ton hours or less. A cleaning cycle of a membrane can be half a year, and a membrane life may be more than 8 years.

Preferably, in an electrodialysis method for selective defluorination, the fluoride concentrations of raw water can be 1.2-2.0 ppm, the hardness of raw water can be 100 ppm-150 ppm (in terms of calcium carbonate), TDS can be 400-600 ppm. Electrodialysis membranes are used for electrodialysis, the selective separation coefficient of the electrodialysis membrane can be −0.3-0.3. The stage of the electrodialysis membrane stack should be 2 and the segment of the electrodialysis membrane stack should be 2. The electrodialysis membrane pairs can be 300 pairs. The electrodialysis membranes of segment 1 should be compressed diffusion boundary layer membranes 180 pairs in total. The flow rate can be 5 m/s and the voltage can be 45 volts. The electrodialysis membranes of segment 2 should be ion exchange membranes 120 pairs in total. The flow rate can be 7.5 m/s and the voltage can be 75 volts. The electrodialysis membrane has a water yield of 90-97%, a dense dilute ratio of 0.3-1.0; K=[k_{liquid}·k_{field}·(k_{membrane}+k_{segment}+k_{stage})]^{k}^{_{chamber}}=0.3-0.5. The electrodialysis membrane also has an output water fluoride concentration of 0.4-0.8 ppm and TDS 200-350 ppm. A direct operation cost could be 0.03 yuan/ton or less and investment could be 1.2 million/ton hours or less. A cleaning cycle of the membrane may be one year, and a membrane life may be more than 8 years.

Preferably, in an electrodialysis method for selective decalcification and defluorination, the fluoride concentrations of raw water can be 1.2-2.0 ppm, the hardness of raw water can be 500 ppm-600 ppm (in terms of calcium carbonate), and TDS can be 400-950 ppm. Electrodialysis membranes are used for electrodialysis, the selective separation coefficient of the electrodialysis membrane can be −0.3-0.3. The stage of the electrodialysis membrane stack should be 2 and the segment of the electrodialysis membrane stack should be 2. The electrodialysis membrane pairs can be 300 pairs. The electrodialysis membranes of segment 1 should be ion exchange membranes 150 pairs in total. The flow rate can be 5 m/s and the voltage can be 65 volts. The electrodialysis membranes of segment 2 should be ion exchange membranes 150 pairs in total. The flow rate can be 5 m/s and the voltage can be 75 volts. The electrodialysis membrane has a water yield of 88-93%, a dense dilute ratio of 0.3-1.0; K=[k_{liquid}·k_{field}·(k_{membrane}+k_{segment}+k_{stage})]^{k}^{_{chamber}}=0.3-0.5. The electrodialysis membrane also has an output water fluoride concentration of 0.4-0.8 ppm, a hardness of 100 ppm-200 ppm (in terms of calcium carbonate), and TDS 200-350 ppm. A direct operation cost could be 0.03 yuan/ton or less and investment could be 1.6 million/ton hours or less. A cleaning cycle of the membrane may be one year, and a membrane life may be more than 8 years.

Preferably, in an electrodialysis method for selective removal of calcium, fluorine, sodium, and bicarbonate, the fluoride concentrations of raw water can be 1.2-2.0 ppm, the hardness of raw water can be 500 ppm-600 ppm (in terms of calcium carbonate), TDS can be 1100-1300 ppm. Electrodialysis membranes are used for electrodialysis, the selective separation coefficient of the electrodialysis membrane can be −0.3-0.3. The stage of the electrodialysis membrane stack should be 2 and the segment of the electrodialysis membrane stack should be 2. The electrodialysis membrane pairs can be 300 pairs. The electrodialysis membranes of segment 1 should be ion exchange membranes 150 pairs in total. The flow rate can be 5 m/s and the voltage can be 65 volts. The electrodialysis membranes of segment 2 should be ion exchange membranes 150 pairs in total. The flow rate can be 5 m/s and the voltage can be 75 volts. The electrodialysis membrane has a water yield of 88-93%, a dense dilute ratio of 0.3-1.0; K=[k_{liquid}·k_{field}·(k_{membrane}+k_{segment}+k_{stage})]^{k}^{_{chamber}}=0.3-0.5 . The electrodialysis membrane also has an output water fluoride concentration of 0.4-0.8 ppm, a hardness of 100 ppm-200 ppm (in terms of calcium carbonate), and TDS 200-350 ppm. A direct operation cost could be 0.03 yuan/ton or less and investment could be 1.6 million/ton hours or less. A cleaning cycle of a membrane may be one year, and a membrane life may be more than 8 years.

Preferably, in an electrodialysis method for selective denitrification, the nitrate concentration of raw water can be 15 ppm-400 ppm, and TDS can be 400-950 ppm. Electrodialysis membranes are used for electrodialysis, the selective separation coefficient of the electrodialysis membrane can be −0.3-0.3. The stage of the electrodialysis membrane stack should be 1 and the segment of the electrodialysis membrane stack should be 2. The electrodialysis membrane pairs can be 300 pairs. The electrodialysis membranes of segment 1 should be ion exchange membranes 150 pairs in total. The flow rate can be 5 m/s and the voltage can be 55 volts. The electrodialysis membranes of segment 2 should be ion exchange membranes 150 pairs in total. The flow rate can be 5 m/s and the voltage can be 55 volts. The electrodialysis membrane has a water yield of 90-97%, a dense dilute ratio of 0.3-1.0; K=[k_{liquid}·k_{field}·(k_{membrane}+k_{segment}+k_{stage})]^{k}^{_{chamber}}=0.3-0.5. The electrodialysis membrane also has an output water nitrate concentration of 10 ppm or less. A direct operation cost could be 0.03 yuan/ton or less and investment could be 1.6 million/ton hours or less. A cleaning cycle of a membrane may be one year, and a membrane life may be more than 8 years.

Preferably, in an electrodialysis method for selective arsenic removal, the arsenic concentration of raw water can be 10.0-50.0 ppb, and TDS can be 400-950 ppm. Electrodialysis membranes are used for electrodialysis, the selective separation coefficient of the electrodialysis membrane can be −0.3-0.3. The stage of the electrodialysis membrane stack should be 2, the segment of the electrodialysis membrane stack should be 3 and the chamber of the electrodialysis membrane stack should be 4. The electrodialysis membrane pairs can be 300 pairs. Stage 1 includes 1 segment. The segment includes 100 cyclic electrodialysis membrane pairs in total, and each cyclic electrodialysis membrane pair includes 4 chambers. The chambers are separated by ion exchange membranes, the flow rate can be 5 m/s and the voltage can be 55 volts. Stage 2 includes 2 segments. Segment 1 includes 100 cyclic electrodialysis membrane pairs in total, and each cyclic electrodialysis membrane pair includes 4 chambers. The chambers are separated by ion exchange membranes, the flow rate can be 5 m/s and the voltage can be 55 volts. Segment 2 includes electrodialysis membrane pairs, and each cyclic electrodialysis membrane pair includes 2 or 4 chambers. When the number of chambers is 2, the cyclic electrodialysis membrane pairs should be common membrane pairs, the common membrane pairs may be separated by the ion exchange membrane. When the number of chambers is 4, the cyclic electrodialysis membrane pairs should be special membrane pairs. The special membrane pair could be divided into 2 chambers by the ion exchange membrane and then divided into 2 chambers by the bipolar membrane. The number of chambers divided by the bipolar membrane accounts for 3-10% of the total chamber number. The electrodialysis membrane has a water yield of 88-93%, a dense dilute ratio of 0.3-1.0; K=[k_{liquid}·k_{field}·(k_{membrane}+k_{segment}+k_{stage})]^{k}^{_{chamber}}=0.3-0.5. The electrodialysis membrane also has an output water fluoride concentration of 0.4-0.8 ppm, a hardness of 100 ppm-200 ppm (in terms of calcium carbonate), and TDS 200-350 ppm. A direct operation cost could be 0.03 yuan/ton or less and investment could be 1.6 million/ton hours or less. A cleaning cycle of a membrane may be one year, and a membrane life may be more than 8 years.

Preferably, in an electrodialysis method for selective high concentration boron removal, the arsenic concentration of raw water can be 5.0-10.0 ppm, and TDS can be 30000-45000 ppm. Ion exchange membranes are used for electrodialysis. The stage of the electrodialysis membrane stack should be 3, the segment of the electrodialysis membrane stack should be 5 and the chamber of the electrodialysis membrane stack should be 4. The electrodialysis membrane pairs can be 300 pairs and each segment includes 60 pairs. Stage 1 includes 2 segments. Each cyclic electrodialysis membrane pair includes 2 chambers. The chambers are separated by controllable channel membranes, the flow rate can be 0.5 m/s and the constant current can be 2A. Stage 2 includes 2 segments. Each segment includes cyclic electrodialysis membrane pair and each cyclic electrodialysis membrane pair includes 4 chambers. The chambers are separated by controllable channel membranes, the flow rate can be 0.5 m/s and the constant current can be 1.3A. Stage 3 includes 1 segment. The segment includes electrodialysis membrane pairs, and each cyclic electrodialysis membrane pair includes 2 or 4 chambers. When the number of chambers is 2, the cyclic electrodialysis membrane pairs should be common membrane pairs, the common membrane pairs may be separated by the ion exchange membrane. When the number of chambers is 4, the cyclic electrodialysis membrane pairs should be special membrane pairs. The special membrane pair could be divided into 2 chambers by the ion exchange membrane and then divided into 2 chambers by the bipolar membrane. The number of chambers divided by the bipolar membrane accounts for 3-10% of the total chamber number. This stage has a constant pressure of 0.5 volts. This stage also has an output water boron concentration of 4.5 ppm or less, TDS 500 ppm or less. A direct operation cost could be 0.03 yuan/ton or less and investment could be 1.6 million/ton hours or less. A cleaning cycle of the membrane may be one year, and a membrane life may be more than 8 years. The selective separation coefficient of the electrodialysis membrane can be 0.9 or more. A direct operation cost could be 0.05 yuan/ton or less and investment could be 1.2 million/ton hours or less. A cleaning cycle of the membrane can be half a year, and a membrane life may be more than 8 years.

According to the method, the diffusion boundary layer is fully compressed by controlling the electrodialysis membrane, the electrodialysis membrane stack, and the electrodialysis process parameters. So the competitive electromigration rate of the target ions is improved. Meanwhile, according to the method, the initial concentration effect, the competition effect, the synergistic effect, the concentration diffusion, the differential pressure permeation, and other influences of electrodialysis are integrated for selectively removing the target ions. The present method discloses a usage mode of a stage, a segment, and a chamber of a specific electrodialysis membrane stack, which achieves excellent separation performance. The separation coefficient K value can be 0.3-0.5. It significantly reduces the cost of water treatment and improves the long-term stability and operational applicability of the device. the method can achieve a good removal effect on specific ions by means of a specific assembly mode of the material and set specific conditions and is low in cost.

### DESCRIPTION OF THE DRAWINGS

FIG. 1 is a diagram of the influence of an initial ion concentration on membrane resistance;

FIG. 2 is a diagram of the principle of electrodialysis.

FIG. 3 is a diagram of an assembly mode of stages and segments of an electrodialysis membrane stack;

FIG. 4 is a diagram of a membrane pair in an electrodialysis membrane stack;

FIG. 5 is a diagram of the circulation backflow of a chamber in an electrodialysis membrane stack;

FIG. 6 is a diagram of a two-stage two-segment two-chamber electrodialysis membrane stack;

FIG. 7 is a schematic diagram of a two-stage three-segment four-chamber electrodialysis membrane stack;

FIG. 8 is a schematic diagram of a three-stage five-segment four-chamber electrodialysis membrane stack.

### DETAILED DESCRIPTION OF PREFERRED EMBODIMENTS

The technical solutions of the present disclosure are further described in detail below with reference to specific embodiments and drawings. It should be noted that the terminology used herein is for the purpose of describing particular embodiments only and is not intended to limit the embodiments according to the disclosure. As used herein, the singular forms are intended to include the plural forms as well, unless the context clearly indicates otherwise.

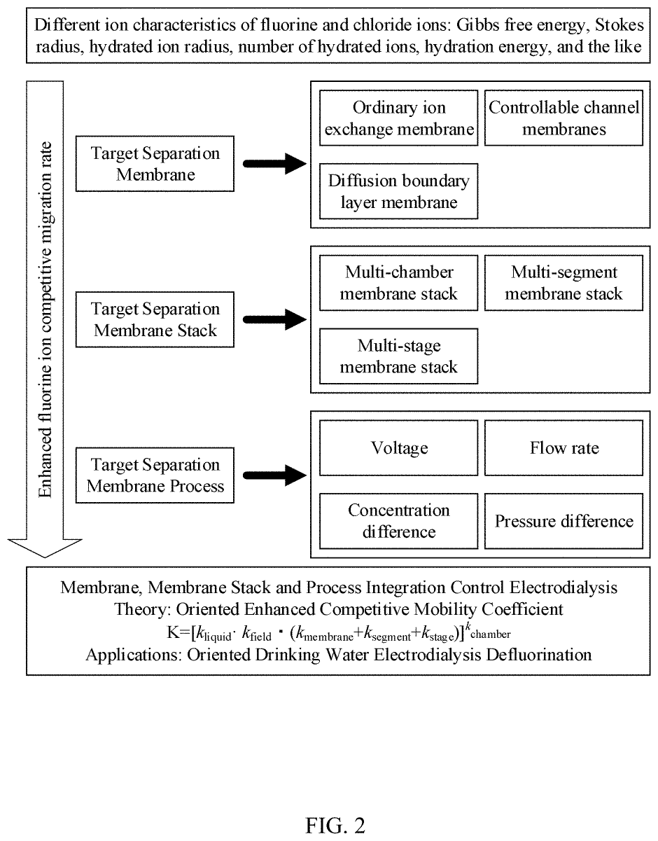

The principle of electrodialysis used in the method of the present disclosure is shown in FIG. 2, and a functioning relationship of a selective separation coefficient for selective removal of target ions by the method of the present disclosure, as shown below:

K=[k_{liquid}·k_{field}·(k_{membrane}+k_{segment}+k_{stage})]^{k}^{_{chamber}}.

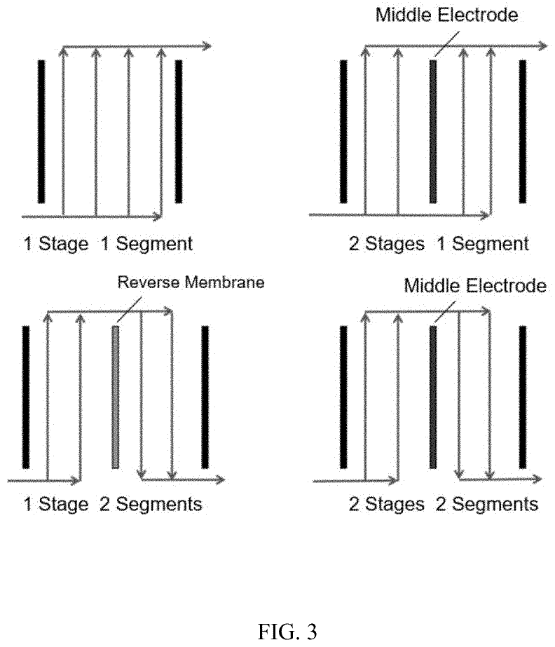

In some embodiments, stages, and segments of the electrodialysis membrane stack assembly mode are shown in FIG. 3. FIG. 3 is merely used as a presentation to help understand and does not constitute a limitation on the present disclosure.

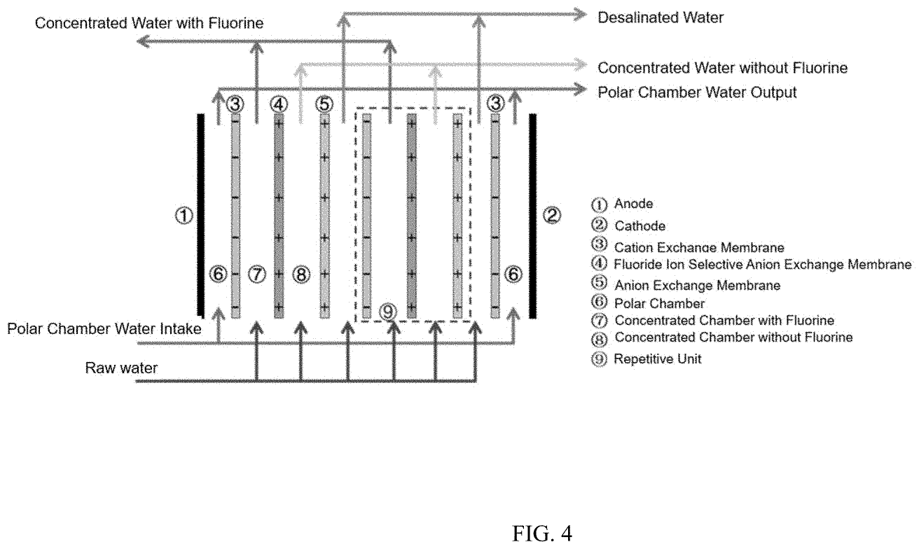

In some embodiments, the membrane pairs in the electrodialysis membrane stack are shown in FIG. 4. An electrodialysis membrane pair is formed by the electrodialysis membrane, and the circulation is repeated. FIG. 4 is merely a demonstration of membrane pairs, which helps to understand and does not constitute a limitation on the present disclosure.

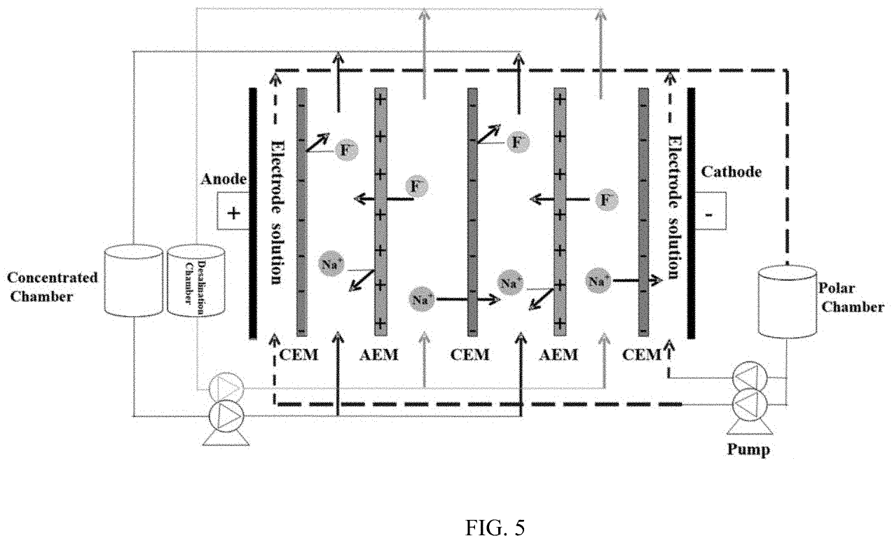

In some embodiments, the circulation reflux of the chamber in the electrodialysis membrane stack is shown in FIG. 5. Each same chamber is circulated and refluxed, and the reflux ratio of each same chamber is 1-4. The same chamber means that the desalination chamber refluxes in the desalination chamber and the concentrated chamber refluxes in the concentrated chamber, and the desalination chamber does not reflux with the concentrated chamber. The diagram is a determined embodiment, which helps to understand and does not constitute a limitation on the present disclosure.

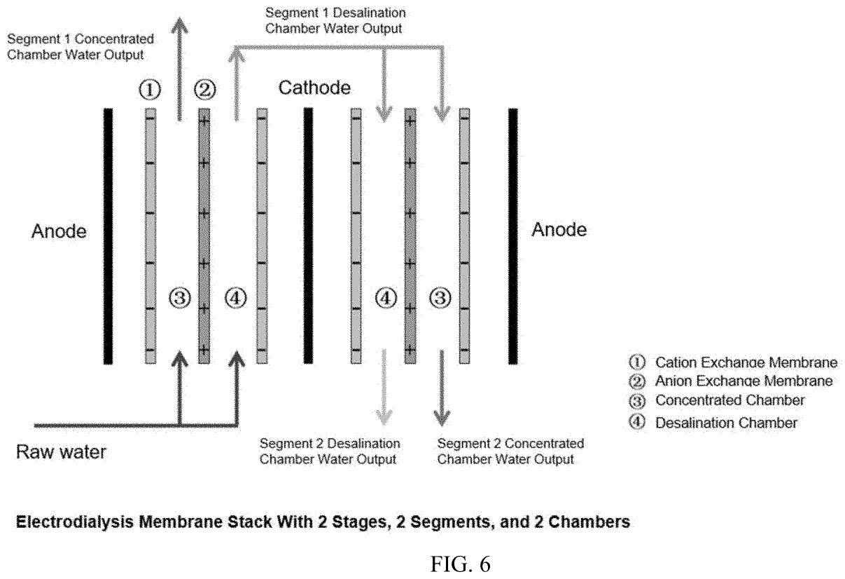

In some embodiments, the electrodialysis membrane stack with 2 stages, 2 segments, and 2 chambers is shown in FIG. 6. It is composed of 2 anodes and 1 cathode, and includes cation exchange membranes and anion exchange membranes. And a chamber separated by ion exchange membranes. The diagram is a determined embodiment, which helps to understand and does not constitute a limitation on the present disclosure.

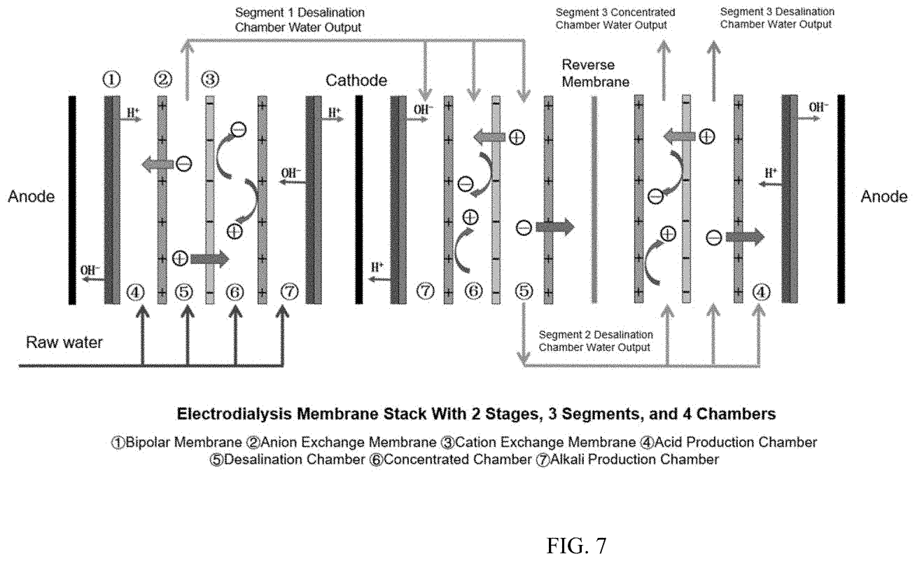

In some embodiments, the electrodialysis membrane stack with 2 stages, 3 segments, and 4 chambers is shown in FIG. 7. It is composed of 2 anodes and 1 cathode, and includes cation exchange membranes, anion exchange membranes, and bipolar membranes. And a chamber separated by ion exchange membranes. The diagram is a determined embodiment, which helps to understand and does not constitute a limitation on the present disclosure.

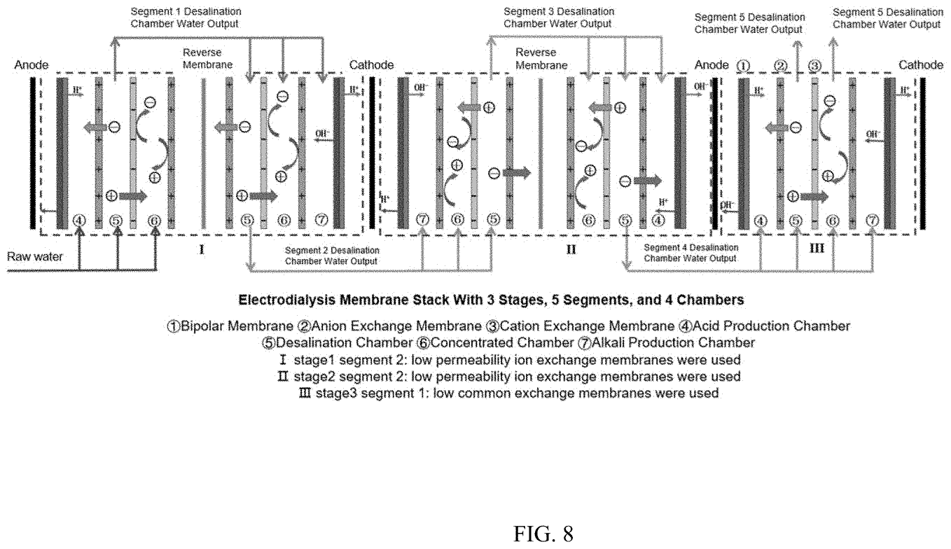

In some embodiments, the electrodialysis membrane stack with 3 stages, 5 segments, and 4 chambers is shown in FIG. 8. It is composed of 2 anodes and 2 cathodes, and includes cation exchange membranes, anion exchange membranes, bipolar membranes, low permeability ion exchange membranes and reverse membranes. And a chamber separated by ion exchange membranes. The low permeability ion exchange membrane is a controllable channel membrane, and the reverse membrane is used as a separation membrane of a segment of the same stage. The diagram is a determined embodiment, which helps to understand and does not constitute a limitation on the present disclosure.

### Embodiment 1

### An Electrodialysis Method for Selectivity Removal of Hardness

The hardness of raw water was 600 ppm (in terms of calcium carbonate), and TDS can be 900 ppm. Electrodialysis membranes are used for electrodialysis, the selective separation coefficient of the electrodialysis membrane was 0.8. The stage of the electrodialysis membrane stack was 1 and the segment of the electrodialysis membrane stack was 1. The electrodialysis membrane pairs were 300 pairs, the flow was 6 m/s and the voltage was 45 volts. The electrodialysis membrane had a water yield of 90%, a dense dilute ratio of 1.0; K=[k_{liquid}·k_{field}·(k_{membrane}+k_{segment}+k_{stage})]^{k}^{_{chamber}}=0.9. The electrodialysis membrane also had an output water hardness of 300 mg/L and TDS 500 ppm. A direct operation cost was 0.05 yuan/ton or less and investment was 1.2 million/ton hours or less. The cleaning cycle of the membrane was half a year, and the membrane life was more than 8 years.

### Embodiment 2

### An Electrodialysis Method for Selective Defluorination

The fluoride concentrations of raw water can be 2.0 ppm, the hardness of raw water was 150 ppm (in terms of calcium carbonate), and TDS was 600 ppm. The electrodialysis membranes were used for electrodialysis, the selective separation coefficient of the electrodialysis membrane was 0.3. The stages of the electrodialysis membrane stack were 2 and the segments of the electrodialysis membrane stack were 2. The electrodialysis membrane pairs were 300 pairs. The electrodialysis membranes of segment 1 were compressed diffusion boundary layer membranes 180 pairs in total. The flow rate was 5 m/s and the voltage was 45 volts. The electrodialysis membranes of segment 2 were ion exchange membranes of 120 pairs in total. The flow rate was 7.5 m/s and the voltage was 75 volts. The electrodialysis membrane had a water yield of 97%, a dense dilute ratio of 1.0; K=[k_{liquid}·k_{field}·(k_{membrane}+k_{segment}+k_{stage})]^{k}^{_{chamber}}=0.5. The electrodialysis membrane also had an output water fluoride concentration of 0.8 ppm, TDS 350 ppm. A direct operation cost was 0.03 yuan/ton or less and investment was 1.2 million/ton hours or less. The cleaning cycle of the membrane was one year, and the membrane life was more than 8 years.

### Embodiment 3

### An Electrodialysis Method for Selective Decalcification and Defluorination

The fluoride concentrations of raw water can be 2.0 ppm, the hardness of raw water can be 600 ppm (in terms of calcium carbonate), and TDS can be 950 ppm. Electrodialysis membranes are used for electrodialysis, the selective separation coefficient of the electrodialysis membrane can be 0.3. The stage of the electrodialysis membrane stack should be 2 and the segment of the electrodialysis membrane stack should be 2. The electrodialysis membrane pairs can be 300 pairs. The electrodialysis membranes of segment 1 should be ion exchange membranes 150 pairs in total. The flow rate can be 5 m/s and the voltage can be 65 volts. The electrodialysis membranes of segment 2 should be ion exchange membranes 150 pairs in total. The flow rate can be 5 m/s and the voltage can be 75 volts. The electrodialysis membrane has a water yield of 93%, a dense dilute ratio of 1.0; K=[k_{liquid}·k_{field}·(k_{membrane}+k_{segment}+k_{stage})]^{k}^{_{chamber}}=0.5. The electrodialysis membrane also has an output water fluoride concentration of 0.8, hardness of 200 ppm (in terms of calcium carbonate), and TDS of 350 ppm. A direct operation cost could be 0.03 yuan/ton or less and investment could be 1.6 million/ton hours or less. A cleaning cycle of the membrane may be one year, and a membrane life may be more than 8 years.

### Embodiment 4

### An Electrodialysis Method for Selective Removal of Calcium, Fluorine, Sodium, Bicarbonate

The fluoride concentration of raw water was 2.0 ppm, the hardness of raw water was 600 ppm (in terms of calcium carbonate), and TDS was 1300 ppm. Electrodialysis membranes were used for electrodialysis, the selective separation coefficient of the electrodialysis membrane was 0.3. The stages of the electrodialysis membrane stack were 2 and the segments of the electrodialysis membrane stack were 2. The electrodialysis membrane pairs were 300 pairs. The electrodialysis membranes of segment 1 were ion exchange membranes with 150 pairs in total. The flow rate was 5 m/s and the voltage was 65 volts. The electrodialysis membranes of segment 2 were ion exchange membranes with 150 pairs in total. The flow rate was 5 m/s and the voltage was 75 volts. The electrodialysis membrane has a water yield of 93%, a dense dilute ratio of 1.0; K=[k_{liquid}·k_{field}·(k_{membrane}+k_{segment}+k_{stage})]^{k}^{_{chamber}}=0.5.

The electrodialysis membrane also had an output water fluoride concentration of 0.8 ppm, a hardness of 200 ppm (in terms of calcium carbonate), and TDS of 350 ppm. A direct operation cost was 0.03 yuan/ton or less and investment was 1.6 million/ton hours or less. The cleaning cycle of the membrane may be one year, and the membrane life may be more than 8 years.

### Embodiment 5

### An Electrodialysis Method for Selective Denitrification

The nitrate concentration of raw water was 400 ppm, and TDS was 950 ppm. The electrodialysis membranes were used for electrodialysis, the selective separation coefficient of the electrodialysis membrane was 0.3. The stage of the electrodialysis membrane stack was 1 and the segments of the electrodialysis membrane stack were 2. The electrodialysis membrane pairs were 300 pairs. The electrodialysis membranes of segment 1 were ion exchange membranes with 150 pairs in total. The flow rate was 5 m/s and the voltage was 55 volts. The electrodialysis membranes of segment 2 were ion exchange membranes with 150 pairs in total. The flow rate was 5 m/s and the voltage was 55 volts. The electrodialysis membrane had a water yield of 97%, a dense dilute ratio of 1.0; K=[k_{liquid}·k_{field}·(k_{membrane}+k_{segment}+k_{stage})]^{k}^{_{chamber}}=0.5. The electrodialysis membrane also had an output water nitrate concentration of 10 ppm or less. A direct operation cost was 0.03 yuan/ton or less and investment was 1.6 million/ton hours or less. The cleaning cycle of the membrane may be one year, and the membrane life was more than 8 years.

### Embodiment 6

### An Electrodialysis Method for Selective Arsenic Removal

The arsenic concentration of raw water was 50.0 ppb, and TDS was 950 ppm. The electrodialysis membranes were used for electrodialysis, the selective separation coefficient of the electrodialysis membrane was 0.3. The stages of the electrodialysis membrane stack were 2, the segments of the electrodialysis membrane stack were 3 and the chambers of the electrodialysis membrane stack were 4. The electrodialysis membrane pairs were 300 pairs. Stage 1 included 1 segment. The segment included 100 cyclic electrodialysis membrane pairs in total, and each cyclic electrodialysis membrane pair included 4 chambers. The chambers were separated by ion exchange membranes, the flow rate was 5 m/s and the voltage was 55 volts. Stage 2 included 2 segments. Segment 1 included 100 cyclic electrodialysis membrane pairs in total, and each cyclic electrodialysis membrane pair included 4 chambers. The chambers were separated by ion exchange membranes, the flow rate was 5 m/s and the voltage was 55 volts. Segment 2 included electrodialysis membrane pairs, and each cyclic electrodialysis membrane pair included 2 or 4 chambers. When the number of chambers was 2, the cyclic electrodialysis membrane pairs were common membrane pairs, the common membrane pairs were separated by the ion exchange membrane. When the number of chambers was 4, the cyclic electrodialysis membrane pairs were special membrane pairs. The special membrane pairs were divided into 2 chambers by the ion exchange membranes and then divided into 2 chambers by the bipolar membranes. The number of chambers divided by the bipolar membrane accounted for 10% of the total chamber number. The electrodialysis membrane had a water yield of 93%, a dense dilute ratio of 0.3-1.0; K=[k_{liquid}·k_{field}·(k_{membrane}+k_{segment}+k_{stage})]^{k}^{_{chamber}}=0.5. The electrodialysis membrane also had an output water fluoride concentration of 0.8 ppm, a hardness of 200 ppm (in terms of calcium carbonate), and a TDS of 350 ppm. A direct operation cost was 0.03 yuan/ton or less and investment was 1.6 million/ton hours or less. A cleaning cycle of the membrane was one year, and the membrane life was more than 8 years.

### Embodiment 7

### An Electrodialysis Method for Selective High Concentration Boron Removal

The arsenic concentration of raw water was 10.0 ppm, and TDS was 45000 ppm. Ion exchange membranes were used for the electrodialysis. The stages of the electrodialysis membrane stack were 3, the segments of the electrodialysis membrane stack were 5 and the chambers of the electrodialysis membrane stack were 4. The electrodialysis membrane pairs were 300 pairs and each segment included 60 pairs. Stage 1 included 2 segments. Each cyclic electrodialysis membrane pair included 2 chambers. The chambers were separated by controllable channel membranes, the flow rate was 0.5 m/s and the constant current was 2 A. Stage 2 included 2 segments. Each segment included cyclic electrodialysis membrane pair and each cyclic electrodialysis membrane pair included 4 chambers. The chambers were separated by controllable channel membranes, the flow rate was 0.5 m/s and the constant current was 1.3 A. Stage 3 includes 1 segment. The segment included electrodialysis membrane pairs, and each cyclic electrodialysis membrane pair included 2 or 4 chambers. When the number of chambers was 2, the cyclic electrodialysis membrane pairs were common membrane pairs, the common membrane pairs were separated by the ion exchange membrane. When the number of chambers is 4, the cyclic electrodialysis membrane pairs were special membrane pairs. The special membrane pairs were divided into 2 chambers by the ion exchange membrane and then divided into 2 chambers by the bipolar membrane. The number of chambers divided by the bipolar membrane accounted for 3-10% of the total chamber number. This stage had a constant pressure of 0.5 volts. This stage also had an output water boron concentration of 4.5 ppm or less, TDS 500 ppm or less. A direct operation cost could be 0.03 yuan/ton or less and investment was 1.6 million/ton hours or less. A cleaning cycle of the membrane was one year, and the membrane life was more than 8 years. The selective separation coefficient of the electrodialysis membrane was 0.9. A direct operation cost was 0.05 yuan/ton or less and investment was 1.2 million/ton hours or less. The cleaning cycle of the membrane was half a year, and the membrane life was more than 8 years.

### Embodiment 8

### An Electrodialysis Method for Selective Defluorination

Respectively added a respective corresponding solution into each water tank of the device. A sodium sulfate solution with a concentration of 2 L of 0.1 mol/L was added into the polar chamber water tank, and the concentration chamber water tank and the desalination chamber water tank were introduced into a simulated underground water solution 5L having the same concentration. Sodium chloride and sodium fluoride were used as research objects, the sodium chloride concentration was set to 500 ppm, and the sodium fluoride concentration was set to 2 ppm, respectively.

Then, the circulating pump corresponding to each water tank was turned on, that is, the circulation pumps provided on conduits connecting each tank to the corresponding compartments in the membrane stack were opened. The corresponding circulating flow rate was adjusted, and the flow rate of the solution in each water tank was controlled to be 6 L/h.

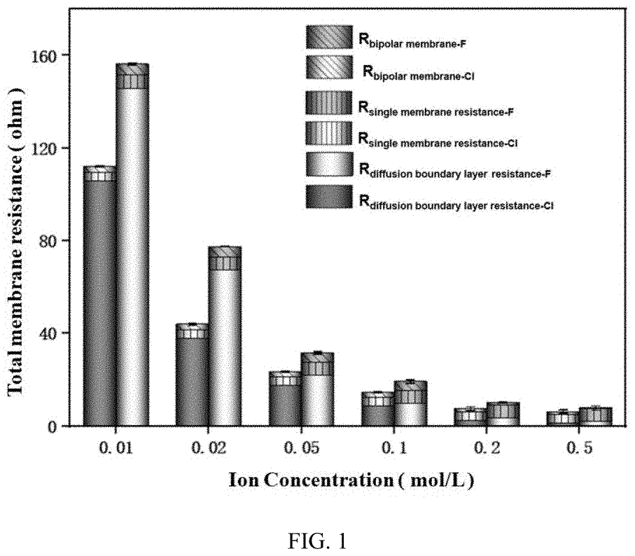

Then, a direct current power supply was turned on (the negative electrode of the power supply was connected to the cathode of the membrane stack, and the positive electrode of the power supply was connected to the anode of the membrane stack. FIG. 1). It was in a constant voltage state, the voltage was controlled to be 10 V.

The membrane stack used in this embodiment was composed of 3 groups of ion exchange membranes. Each group had 9 ion exchange membranes (electrode membranes, anion exchange membranes, and cation exchange membranes). The effective area of each membrane was 110 mm×270 mm=29700 mm².

During operation, the conductivity analysis instrument was used to measure the conductivity in the concentration chamber water tank in real-time. When conductivity was observed to be stable, it is considered that the reaction was ended. Then processing was stopped, and the power supply was turned off.

### Embodiment 9

### An Electrodialysis Method for Selective Defluorination

Compared with embodiment 8, this embodiment differs only in that the concentration of sodium fluoride was set to 4 ppm, respectively.

### Embodiment 10

### An Electrodialysis Method for Selective Defluorination

Compared with embodiment 8, this embodiment differs only in that the concentration of sodium fluoride was set to 6 ppm, respectively.

### Embodiment 11

### An Electrodialysis Method for Selective Defluorination

Compared with embodiment 8, this embodiment differs only in that the concentration of sodium fluoride was set to 8 ppm, respectively.

### Embodiment 12

An electrodialysis method for selective defluorination

Compared with embodiment 8, this embodiment differs only in that the concentration of sodium fluoride was set to 10 ppm, respectively.

### Embodiment 13

### An Electrodialysis Method for Selective Defluorination

This embodiment differs from Example 8 only in the following aspects:

The concentration of sodium fluoride was set to 3 ppm, respectively; the electric field intensity was 5V, and the water inlet flow rate was 12 L/h.

### Embodiment 14

### An Electrodialysis Method for Selective Defluorination

This embodiment differs from Example 8 only in the following aspects:

The concentration of sodium fluoride was set to 3 ppm, respectively; the electric field intensity was 10 V, and the water inlet flow rate was 12 L/h.

### Embodiment 15

### An Electrodialysis Method for Selective Defluorination

This embodiment differs from Example 8 only in the following aspects:

The concentration of sodium fluoride was set to 3 ppm, respectively; the electric field intensity was 15 V, and the water inlet flow rate was 12 L/h.

### Embodiment 16

### An Electrodialysis Method for Selective Defluorination

This embodiment differs from Example 8 only in the following aspects:

The concentration of sodium fluoride was set to 3 ppm, respectively; the electric field intensity was 20 V, and the water inlet flow rate was 12 L/h.

### Embodiment 17

An electrodialysis method for selective defluorination

This embodiment differs from Example 8 only in the following aspects:

The concentration of sodium fluoride was set to 3 ppm, respectively; the electric field intensity was 25 V, and the water inlet flow rate was 12 L/h.

### Embodiment 18

### An Electrodialysis Method for Selective Defluorination

This embodiment differs from Example 8 only in the following aspects:

The concentration of sodium fluoride was set to 3 ppm, respectively; the electric field intensity was 30 V, and the water inlet flow rate was 12 L/h.

### Embodiment 19

### An Electrodialysis Method for Selective Defluorination

This embodiment differs from Example 8 only in the following aspects:

The concentration of sodium fluoride was set to 3 ppm, respectively; the electric field intensity was 15 V, and the water inlet flow rate was 6 L/h.

### Embodiment 20

### An Electrodialysis Method for Selective Defluorination

This embodiment differs from Example 8 only in the following aspects:

The concentration of sodium fluoride was set to 3 ppm, respectively; the electric field intensity was 15 V, and the water inlet flow rate was 12 L/h.

### Embodiment 21

### An Electrodialysis Method for Selective Defluorination

This embodiment differs from Example 8 only in the following aspects:

The concentration of sodium fluoride was set to 3 ppm, respectively; the electric field intensity was 15 V, and the water inlet flow rate was 18 L/h.

### Embodiment 22

### An Electrodialysis Method for Selective Defluorination

This embodiment differs from Example 8 only in the following aspects:

The concentration of sodium fluoride was set to 3 ppm, respectively; the electric field intensity was 15 V, and the water inlet flow rate was 24 L/h.

### Embodiment 23

### An Electrodialysis Method for Selective Defluorination

This embodiment differs from Example 8 only in the following aspects:

The concentration of sodium fluoride was set to 3 ppm, respectively; the electric field intensity was 15 V, and the water inlet flow rate was 30 L/h.

### Test Example

### 1. Effect of Different Initial Fluorine Concentrations on Defluorination

The concentrations of sodium fluoride and sodium chloride in the desalination chamber water tank in Examples 8-12 were analyzed and determined respectively.

The fluorine ion selective separation efficiency in electrodialysis is calculated according to the following formula:

$${S}_{B}^{A} = \frac{{C}_{A ( t )} / {C}_{A ( 0 )} - {C}_{B ( t )} / {C}_{B ( 0 )}}{( 1 - {C}_{A ( t )} / {C}_{A ( 0 )} ) + ( 1 - {C}_{B ( t )} / {C}_{B ( 0 )} )} ;$$

wherein, C_{A(t)} is the ion concentration of A ion at time t; C_{A(0)} is the initial ion concentration of A ion; C_{B(t)} is the ion concentration of B ion at time t; C_{B(0)} is the ion concentration of B ion. The S value range is −1 to 1 depending on the mass transfer rate of the fluoride and chloride ions. If the A ion mass transfer rate is higher than B ions, the S value is between −1 and 0; otherwise, the S value is between 0 and 1.

The concentration of sodium chloride and sodium fluoride in the desalination chamber water tank was analyzed by using an ion chromatograph, and the determination result is shown in Table 1.

TABLE 1
Ion Concentration of the Treated Water after Guided Electrodialysis
Based on Different Initial Concentrations.

| | Embodiment | Embodiment | Embodiment | Embodiment | Embodiment |
|---|---|---|---|---|---|
| | 8 | 9 | 10 | 11 | 12 |
| After processing | 28.1 | 21.5 | 21.8 | 22.8 | 30.6 |
| C_{(NaCl)}/ppm | | | | | |
| After processing | 0.26 | 0.36 | 0.45 | 0.57 | 0.69 |
| C_{(NaF)}/ppm | | | | | |
| Selective separation | 0.157 | 0.182 | 0.207 | 0.216 | 0.227 |
| coefficient | | | | | |

The selective separation effect of fluorine ions in electrodialysis is shown in Table 2. The concentration of fluorine ions and chloride ions in each group of water samples can reach the standard of the drinking water specified by the World Health Organization (WHO). Improving the initial fluoride ion concentration can slightly improve the selectivity separation efficiency of the fluorine ions. After analyzing the resistance of the diffusion boundary layer on the surface of the ion exchange membrane, it is found that when the ion concentration is low, the diffusion boundary layer resistor RDBL is the main control factor of the film resistor. However, the influence of the concentration change of 2 -10 ppm on RDBL is relatively weak, so that the fluorine ion selective separation efficiency is not obvious with the concentration change.

### 2. Effect of Different Voltage on Defluorination

The results of the measurement in embodiment 13-18 are shown in Table 2.

TABLE 2
Ion Concentration of the Treated Water after Guided Electrodialysis Based on Different Electric Fields.

| | Embodiment 13 | Embodiment 14 | Embodiment 15 | Embodiment 16 | Embodiment 17 | Embodiment 18 |
|---|---|---|---|---|---|---|
| After processing | 56.5 | 20.6 | 25.5 | 7.44 | 5.36 | 5.07 |
| C_{(NaCl)}/ppm | | | | | | |
| After processing | 0.61 | 0.53 | 0.43 | 0.1 | 0.08 | 0.08 |
| C_{(NaF)}/ppm | | | | | | |
| Selective | 0.062 | 0.129 | 0.172 | 0.261 | 0.283 | 0.358 |
| separation | | | | | | |
| coefficient | | | | | | |

The selective separation effect of fluorine ions in electrodialysis is shown in Table 2.The concentration of fluorine ions and chloride ions in each group of water samples can reach the standard of the drinking water specified by the World Health Organization (WHO). Improving the intensity of the external electric field can improve the selectivity separation efficiency of the fluorine ions. After analyzing the resistance of the diffusion boundary layer on the surface of the ion exchange membrane, it is found that increasing the electric field intensity can decrease the thickness of the DBL, and the RDBL is greatly reduced. So the fluorine ion selective separation efficiency is obviously improved.

### 3. Effect of Different Water Inlet Flow Rates on Defluorination

The results of the measurement in embodiment 19-23 are shown in Table 3.

TABLE 3
Ion Concentration of the Treated Water after Guided Electrodialysis
Based on Different Electric fields.

| | Embodiment | Embodiment | Embodiment | Embodiment | Embodiment |
|---|---|---|---|---|---|
| | 19 | 20 | 21 | 22 | 23 |
| After processing | 33.5 | 26.1 | 14.5 | 7.62 | 5.27 |
| C_{(NaCl)}/ppm | | | | | |
| After processing | 0.44 | 0.23 | 0.14 | 0.09 | 0.06 |
| C_{(NaF)}/ppm | | | | | |
| Selective separation | 0.106 | 0.172 | 0.208 | 0.282 | 0.379 |
| coefficient | | | | | |

The selective separation effect of fluorine ions in electrodialysis is shown in Table 3. The concentration of fluorine ions and chloride ions in each group of water samples can reach the standard of the drinking water specified by the World Health Organization (WHO). Improving the water inlet flow rate can improve the selectivity separation efficiency of the fluorine ions. After analyzing the resistance of the diffusion boundary layer on the surface of the ion exchange membrane, it is found that increasing the water inlet flow rate can decrease the thickness of the DBL, and the RDBL is greatly reduced. So the fluorine ion selective separation efficiency is obviously improved.

The multi-parameter controlled guided defluorination electrodialysis of the present disclosure is applied to a drinking water treatment process, which not only can achieve the standard that the ion components in drinking water meet the specification of WHO, but also can realize competitive migration and separation of fluorine ions in an aqueous solution.

The above embodiments are merely intended to illustrate the present disclosure and are not intended to limit the present disclosure. Various changes and modifications may be made by those skilled in the art without departing from the spirit and scope of the present disclosure. Therefore, all equivalent technical solutions fall within the scope of the present invention.

1. An electrodialysis method for selective removal of drinking water target ions, comprising:
treating raw slightly brackish water by using an electrodialysis desalination process to obtain desalted water;
wherein in the electrodialysis desalination process, the raw slightly brackish water is processed by controlling an electrodialysis membrane, an electrodialysis membrane stack, and electrodialysis process parameters;
wherein a calculation general formula of a selective separation coefficient is:
$${S}_{B}^{A} = \frac{{C}_{A ( t )} / {C}_{A ( 0 )} - {C}_{B ( t )} / {C}_{B ( 0 )}}{( 1 - {C}_{A ( t )} / {C}_{A ( 0 )} ) + ( 1 - {C}_{B ( t )} / {C}_{B ( 0 )} )} ;$$
wherein A representing a target ion, and B representing total dissolved solids in a selected standard ion or actual solution in actual use;
wherein an aperture of the electrodialysis membrane is less than 1 micron; and the selective separation coefficient of the electrodialysis membrane is in a range from −1 to 1;
wherein the electrodialysis membrane is selected from a group comprising a controllable channel membrane, a compression diffusion boundary layer membrane, and an ion exchange membrane;
wherein electrodialysis membrane stack comprises:
two segments, wherein the segment is number of repeated flows of the raw slightly brackish water in the electrodialysis membrane stack;
two stages, wherein a value of the stage is number of electrode plates in the electrodialysis membrane stack reduced by 1; and
two chambers, formed by separating the electrodialysis membrane;
wherein a separation coefficient for selectively removing the target ions is obtained from a following formula:
K=[k_{liquid}·k_{field}·(k_{membrane}+k_{segment}+k_{stage})]^{k}^{_{chamber}};
kₓ represents the selective separation coefficient; x represents a liquid, a field, a membrane, a segment, a stage, or a chamber;
the kx is obtained from a calculation general formula of the selective separation coefficient,
k_{liquid} represents a selective separation coefficient of a target solution;
k_{field} represents an electrodialysis process parameter multi-field control selective separation coefficient such as electrodialysis membrane stack voltage, electrodialysis membrane stack flow rate, concentration difference of a dense dilute chamber, and pressure difference of a dense dilute chamber;
k_{membrane} represents an electrodialysis membrane selective separation coefficient;
k_{segment} represents a membrane selective separation coefficient of electrodialysis membrane stack;
k_{stage} represents a stage selective separation coefficient of electrodialysis membrane stack;
k_{chamber} represents a chamber selective separation coefficient of electrodialysis membrane stack;
a range of K is 0.3-0.9;

2. The electrodialysis method according to claim 1, wherein the controlling of the electrodialysis process parameters comprises controlling parameters of electrodialysis membrane stack voltage, electrodialysis membrane stack flow rate, concentration difference of a dense dilute chamber, and pressure difference of a dense dilute chamber.

3. The electrodialysis method according to claim 1, wherein raw water flow rate in each segment of the electrodialysis membrane stack is greater than 0.5 m/sec or less than 0.5 m/sec, and the voltage in each segment of the electrodialysis membrane stack is greater than 0.5 volts/pair or less than 0.5 volts/pair.

4. The electrodialysis method according to claim 1, wherein total dissolved solids in the raw slightly brackish water is 0.5-40000 ppm.

5. The electrodialysis method according to claim 4, wherein a stage voltage of a first segment of the electrodialysis membrane stack is 0.1-2.0 volts/pair, and voltage of a second segment of the electrodialysis membrane stack is 30-300% of the stage voltage of the first segment.

6. The electrodialysis method according to claim 1, wherein each same chamber of the electrodialysis membrane stack is circulated and refluxed, and a reflux ratio of each same chamber of the electrodialysis membrane stack is 1-4.

7. The electrodialysis method according to claim 1, wherein the chamber of the electrodialysis membrane stack is filled with ion resin, a filling rate is 5-80% by volume.

8. The electrodialysis method according to claim 1, wherein a bipolar membrane chamber is added in the chamber of electrodialysis membrane stack, and a proportion of the bipolar membrane chamber is 1-30% based on number of chambers.
